(19) United States
(12) Patent Application Publication
(10) Pub. No.: US 2007/0197370 A1
(43) Pub. Date: Aug. 23, 2007

(54) Lead zirconate titanate type composition, process for producing the same, piezoelectric body, and piezoelectric device

(75) Inventors: Takashi Nakamura, Ashigarakami-gun (JP); Takami Arakawa, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/709,710

(22) Filed: Feb. 23, 2007

(30) Foreign Application Priority Data
Feb. 23, 2006 (JP) 2006-046375

(51) Int. Cl. C04B 35/00

(52) U.S. Cl. 501/134; 252/62.9 PZ

(57) ABSTRACT

A lead zirconate titanate type composition contains a three-component system lead zirconate titanate (X), which may be represented by the general formula of Pb(Ni, Nb)O₃—PbZrO₃—PbTiO₃, an (A) constituent, which is Pb in excess of a quantity conforming to a stoichiometric ratio, a (B) constituent, which is Zn, and a (C) constituent, which is at least one kind of rare earth element selected from the group consisting of Ce, Yb, and Dy, the (A) constituent, the (B) constituent, and the (C) constituent being added to the three-component system lead zirconate titanate (X).

### BACKGROUND OF THE INVENTION

1. Field of the Invention

This invention relates to a lead zirconate titanate type composition, which principally contains PNN-PZT, i.e. Pb(Ni, Nb)O₃—PbZrO₃—PbTiO₃, and a process for producing the lead zirconate titanate type composition. This invention also relates to a piezoelectric body constituted of the lead zirconate titanate type composition, and a piezoelectric device utilizing the piezoelectric body.

2. Description of the Related Art

Piezoelectric devices provided with a piezoelectric body, which has piezoelectric characteristics such that the piezoelectric body expands and contracts in accordance with an increase and a decrease in electric field applied across the piezoelectric body, and electrodes for applying the electric field across the piezoelectric body have heretofore been used in use applications, such as ink jet type recording heads and ultrasonic probes.

As piezoelectric body materials, there have heretofore been known composite oxides having a perovskite structure, such as lead zirconate titanate (PZT). Ordinarily, the PZT types of piezoelectric bodies are produced with firing processing at high temperatures falling within the range of 1,200° C. to 1,400° C.

In cases where an energy efficiency, or the like, is taken into consideration, the firing processing should preferably be capable of being performed at a low temperature. Also, it often occurs that the piezoelectric body is formed with, for example, a liquid phase technique, such as a sol gel technique or an organometal decomposition technique, and directly on a base material, on which an electrode, or the like, has been formed. In such cases, such that adverse effects on the base material may be suppressed, the firing processing should preferably be capable of being performed at a low temperature.

In, for example, Japanese Unexamined Patent Publication No. 10(1998)-316467, it is disclosed that, in cases where AgO is added to Pb(Zn, Nb)O₃—Pb(Sn, Nb)O₃—PbZrO₃—PbTiO₃ [PZN-PSnN-PZT], the firing temperature is capable of being set at a low temperature, and it becomes possible to perform the firing processing at a temperature falling within the range of 970° C. to 1,070° C.

Also, in, for example, Japanese Unexamined Patent Publication No. 2002-226266, it is disclosed that, in cases where Pb(B1_{1/2}B2_{1/2})O₃, wherein B1 represents Ni and/or Zn, and wherein B2 represents W and/or Mo, is added to Pb(Ni, Nb)O₃—PbZrO₃—PbTiO₃ [PNN-PZT], the firing temperature is capable of being set at a low temperature, and it becomes possible to perform the firing processing at a temperature of 950° C.

With each of the techniques disclosed in, for example, Japanese Unexamined Patent Publication Nos. 10(1998)-316467 and 2002-226266, the firing processing at a temperature of at most 1,000° C. is accomplished. However, with each of the disclosed techniques, the firing temperature higher than 900° C. is necessary. Besides the PZT type, a piezoelectric body, which is capable of being fired at a low temperature of at most 900° C. and which has a piezoelectric modulus required practically, has not yet been reported in the past.

### SUMMARY OF THE INVENTION

The primary object of the present invention is to provide a lead zirconate titanate type composition, which is capable of being fired at a low temperature of at most 900° C. and which has piezoelectric characteristics required practically when being used as a piezoelectric body.

Another object of the present invention is to provide a process for producing the lead zirconate titanate type composition.

A further object of the present invention is to provide a piezoelectric body, which is capable of being fired at a low temperature of at most 900° C. and which has piezoelectric characteristics required practically.

The specific object of the present invention is to provide a piezoelectric device utilizing the piezoelectric body.

The present invention provides a lead zirconate titanate type composition, containing:

i) a three-component system lead zirconate titanate (X), which may be represented by the general formula of Pb(Ni, Nb)O₃—PbZrO₃—PbTiO₃,

ii) an (A) constituent, which is Pb in excess of a quantity conforming to a stoichiometric ratio,

iii) a (B) constituent, which is Zn, and

iv) a (C) constituent, which is at least one kind of rare earth element selected from the group consisting of Ce, Yb, and Dy, the (A) constituent, the (B) constituent, and the (C) constituent being added to the three-component system lead zirconate titanate (X).

The lead zirconate titanate type composition in accordance with the present invention may take on one of various forms, such as a bulk body (e.g., a sintered body), a grinding product of the bulk body, and a film.

The present invention also provides a process for producing a lead zirconate titanate type composition, comprising the steps of:

i) performing molding processing for compression molding raw material particles, which contain the constituent elements of the three-component system lead zirconate titanate (X), the (A) constituent, the (B) constituent, and the (C) constituent, into a predetermined shape, and

ii) performing firing processing for firing a compression molded body having been obtained from the molding processing.

The present invention further provides a piezoelectric body, containing:

i) a three-component system lead zirconate titanate (X), which may be represented by the general formula of Pb(Ni, Nb)O₃—PbZrO₃—PbTiO₃,

ii) an (A) constituent, which is Pb in excess of a quantity conforming to a stoichiometric ratio,

iii) a (B) constituent, which is Zn, and

iv) a (C) constituent, which is at least one kind of rare earth element selected from the group consisting of Ce, Yb, and Dy, the (A) constituent, the (B) constituent, and the (C) constituent being added to the three-component system lead zirconate titanate (X).

With the piezoelectric body in accordance with the present invention, it is possible to obtain a piezoelectric body, which has characteristics such that a firing temperature at the time of production falls within the range of 800° C. to 900° C., and such that a piezoelectric modulus d₃₃ is equal to at least 600 pm/V.

Regardless of the composition, the piezoelectric body itself, which is capable of being fired at the firing temperature described above and which has the piezoelectric modulus described above, is novel.

Specifically, the present invention still further provides a piezoelectric body, which has characteristics such that a firing temperature at the time of production falls within the range of 800° C. to 900° C., and such that a piezoelectric modulus d₃₃ is equal to at least 600 pm/V.

The term “piezoelectric modulus d₃₃” as used herein means the quantity of displacement (pm/V) of the piezoelectric body per unit applied voltage, which displacement occurs when a predetermined voltage is applied across the piezoelectric body. The quantity of displacement (pm/V) of the piezoelectric body per unit applied voltage, which displacement occurs when the predetermined voltage is applied across the piezoelectric body, is herein measured with a laser displacement meter (FCE-1, supplied by Toyo Technica Co., Ltd.), and the piezoelectric modulus d₃₃ is calculated from the result of measurement.

The present invention also provides a piezoelectric device, comprising:

i) a piezoelectric body in accordance with the present invention, and

ii) electrodes for applying an electric field across the piezoelectric body.

The lead zirconate titanate type composition in accordance with the present invention is capable of being fired at a low temperature of at most 900° C. and has the piezoelectric characteristics required practically when being used as the piezoelectric body.

The piezoelectric body in accordance with the present invention is capable of being fired at a low temperature of at most 900° C. and has the piezoelectric characteristics required practically. Also, it is possible to accomplish the piezoelectric body, which has the characteristics such that the firing temperature at the time of production falls within the range of 800° C. to 900° C., and such that the piezoelectric modulus d₃₃ is equal to at least 600 pm/V.

The present invention will hereinbelow be described in further detail with reference to the accompanying drawings.

### BRIEF DESCRIPTION OF THE DRAWINGS

FIG. 1 is a sectional view showing an embodiment of the piezoelectric device in accordance with the present invention, and

FIG. 2 is a graph showing evaluation results obtained in Examples 1 to 9.

### DETAILED DESCRIPTION OF THE INVENTION

The lead zirconate titanate type composition in accordance with the present invention is the PNN-PZT type composition. The lead zirconate titanate type composition in accordance with the present invention is characterized by containing:

i) the three-component system lead zirconate titanate (X), which may be represented by the general formula of Pb(Ni, Nb)O₃—PbZrO₃—PbTiO₃,

ii) the (A) constituent, which is Pb in excess of the quantity conforming to the stoichiometric ratio,

iii) the (B) constituent, which is Zn, and

iv) the (C) constituent, which is at least one kind of rare earth element selected from the group consisting of Ce, Yb, and Dy, the (A) constituent, the (B) constituent, and the (C) constituent being added to the three-component system lead zirconate titanate (X).

The molar ratio among the Pb(Ni, Nb)O₃ component, the PbZrO₃ component, and the PbTiO₃ component in the three-component system lead zirconate titanate (X) may be designed arbitrarily and is not limited to a particular ratio.

The molar ratio between Ni and Nb in the Pb(Ni, Nb)O₃ component of the three-component system lead zirconate titanate (X) may be designed arbitrarily and is not limited to a particular ratio. The number of mols of Ni in Pb(Ni, Nb)O₃ should preferably be 1/3, and the number of mols of Nb in Pb(Ni, Nb)O₃ should preferably be 2/3.

The inventors have found that, in cases where the (A) constituent, the (B) constituent, and the (C) constituent described above are added to the three-component system lead zirconate titanate (X), the sinterability is capable of being enhanced, and the sintering at the low temperature of at most 900° C. is capable of being accomplished. Specifically, the inventors have found that it is possible to accomplish the lead zirconate titanate type composition, which is capable of being fired at a low temperature falling within the range of 700° C. to 900° C. and which has the piezoelectric characteristics required practically when being used as the piezoelectric body. In cases where one of the (A) constituent, the (B) constituent, and the (C) constituent described above is omitted from the addition, the effects described above are not capable of being obtained.

No limitation is imposed upon the timing, with which the (A) constituent, the (B) constituent, and the (C) constituent are added. Specifically, the addition of the (A) constituent, the (B) constituent, and the (C) constituent may be performed at the same time as the preparation of the three-component system lead zirconate titanate (X). Alternatively, the addition of the (A) constituent, the (B) constituent, and the (C) constituent may be performed after the preparation of the three-component system lead zirconate titanate (X).

The lead zirconate titanate type composition in accordance with the present invention may take on one of various forms, such as a bulk body (e.g., a sintered body), a grinding product of the bulk body, and a film.

By way of example, the lead zirconate titanate type composition in accordance with the present invention may take on the form of a sintered body having been produced with a process comprising the steps of:

i) compression molding raw material particles, which contain the constituent elements of the three-component system lead zirconate titanate (X), the (A) constituent, the (B) constituent, and the (C) constituent, into a predetermined shape, and

ii) firing a compression molded body having thus been obtained.

The raw material particles may contain the (A) constituent, the (B) constituent, and the (C) constituent in the forms of oxides and/or acid salts (e.g., nitric acid salts or sulfuric acid salts).

By way of example, the raw material particles should preferably be the mixed particles, which contain the particles of the three-component system lead zirconate titanate (X), the particles containing the (A) constituent, the particles containing the (B) constituent, and the particles containing the (C) constituent. In such cases, as the particles of the three-component system lead zirconate titanate (X), particles having been prepared previously may be used. Alternatively, the particles of the three-component system lead zirconate titanate (X) may be prepared from the raw material particles of the three-component system lead zirconate titanate (X). The mixing of the particles may be dry mixing or wet mixing.

The lead zirconate titanate type composition in accordance with the present invention should preferably be modified such that, with respect to 100 parts by mass of the three-component system lead zirconate titanate (X):

a quantity of the (A) constituent added falls within the range of more than 0 part by mass to 8.0 parts by mass, inclusive, expressed in terms of an oxide quantity,

a quantity of the (B) constituent added falls within the range of more than 0 part by mass to 4.0 parts by mass, inclusive, expressed in terms of the oxide quantity, and a quantity of the (C) constituent added falls within the range of more than 0 part by mass to 2.0 parts by mass, inclusive, expressed in terms of the oxide quantity.

The lead zirconate titanate type composition in accordance with the present invention should more preferably be modified such that, with respect to 100 parts by mass of the three-component system lead zirconate titanate (X):

a quantity of the (A) constituent added falls within the range of 1.0 part by mass to 3.0 parts by mass, expressed in terms of an oxide quantity,

a quantity of the (B) constituent added falls within the range of 0.5 part by mass to 1.5 parts by mass, expressed in terms of the oxide quantity, and

a quantity of the (C) constituent added falls within the range of 0.25 part by mass to 0.75 part by mass, expressed in terms of the oxide quantity.

The lead zirconate titanate type composition in accordance with the present invention should most preferably be modified such that, with respect to 100 parts by mass of the three-component system lead zirconate titanate (X):

the quantity of the (A) constituent added is equal to 2.0 parts by mass, expressed in terms of the oxide quantity,

the quantity of the (B) constituent added is equal to 1 part by mass, expressed in terms of the oxide quantity, and

the quantity of the (C) constituent added is equal to 0.5 part by mass, expressed in terms of the oxide quantity.

The quantity of the constituent added, expressed in terms of the oxide quantity, is the quantity expressed in terms of the oxide quantity in cases where the constituent is added in the form of the oxide. Specifically, the quantity of the (A) constituent added is expressed in terms of the PbO quantity. Also, the quantity of the (B) constituent added is expressed in terms of the ZnO quantity. Further, in cases where the (C) constituent contains Ce, the quantity of the (C) constituent added is expressed in terms of the CeO₂ quantity. In cases where the (C) constituent contains Dy, the quantity of the (C) constituent added is expressed in terms of the Dy₂O₃ quantity. In cases where the (C) constituent contains Yb, the quantity of the (C) constituent added is expressed in terms of the Yb₂O₃ quantity.

With the lead zirconate titanate type composition in accordance with the present invention, the firing temperature is capable of being set at a low temperature of at most 900° C. Specifically, with the lead zirconate titanate type composition in accordance with the present invention, the firing temperature is capable of being set at a low temperature falling within the range of 700° C. to 900° C., preferably at a low temperature falling within the range of 800° C. to 900° C. With the lead zirconate titanate type composition in accordance with the present invention, in cases where the composition is fired at the low temperature described above, the piezoelectric characteristics required practically are capable of being obtained when the composition is used as the piezoelectric body. It often occurs that the firing processing is performed in a plurality of stages, e.g. as preliminary firing processing and final firing processing. In such cases, the term “firing temperature” as used herein means the final firing temperature.

No limitation is imposed upon the firing atmosphere. The firing processing should preferably be performed in an oxygen containing atmosphere, such as an air atmosphere. The inventors have found that, in cases where the firing processing is performed in an inert gas atmosphere, such as an Ar gas atmosphere, the piezoelectric modulus is not capable of being kept high (as will be described later in Example 22).

Besides the (X) constituent, the (A) constituent, the (B) constituent, and the (C) constituent, which are the essential constituents, the lead zirconate titanate type composition in accordance with the present invention may contain inevitable impurities. Also, the lead zirconate titanate type composition in accordance with the present invention may contain arbitrary constituents, such as various kinds of additives, in quantities such that the effects of the lead zirconate titanate type composition in accordance with the present invention may not be affected markedly.

The lead zirconate titanate type composition in accordance with the present invention enables the firing at a low temperature of at most 900° C., such that the piezoelectric characteristics, which PNN-PZT fundamentally has, may not be affected markedly. The lead zirconate titanate type composition in accordance with the present invention is advantageous from the view points of the energy efficiency, the energy cost, and the like. Also, in cases where the piezoelectric body constituted of the lead zirconate titanate type composition in accordance with the present invention is formed with, for example, the liquid phase technique, such as the sol gel technique or the organometal decomposition technique, and directly on a base material, on which an electrode, or the like, has been formed, adverse effects of heat on the base material are capable of being suppressed.

[Process for Producing the Lead Zirconate Titanate Type Composition]

The process for producing the lead zirconate titanate type composition in accordance with the present invention comprises the steps of:

i) performing the molding processing for compression molding the raw material particles, which contain the constituent elements of the three-component system lead zirconate titanate (X), the (A) constituent, the (B) constituent, and the (C) constituent, into the predetermined shape, and

ii) performing the firing processing for firing the compression molded body having been obtained from the molding processing.

In the firing processing step, the compression molded body may be fired at a low temperature falling within the range of 700° C. to 900° C., preferably within the range of 800° C. to 900° C. In the firing processing step, the compression molded body should preferably be fired in an oxygen-containing atmosphere, such as an air atmosphere.

[Piezoelectric Body]

The piezoelectric body in accordance with the present invention contains:

i) the three-component system lead zirconate titanate (X), which may be represented by the general formula of Pb(Ni, Nb)O₃—PbZrO₃—PbTiO₃,

ii) the (A) constituent, which is Pb in excess of the quantity conforming to the stoichiometric ratio,

iii) the (B) constituent, which is Zn, and

iv) the (C) constituent, which is at least one kind of rare earth element selected from the group consisting of Ce, Yb, and Dy,

the (A) constituent, the (B) constituent, and the (C) constituent being added to the three-component system lead zirconate titanate (X).

With the piezoelectric body in accordance with the present invention, it is possible to set the firing temperature at a low temperature falling within the range of 700° C. to 900° C., preferably within the range of 800° C. to 900° C. With the piezoelectric body in accordance with the present invention, it is possible to obtain the piezoelectric body, which has the characteristics such that the firing temperature at the time of the production falls within the range of 800° C. to 900° C., and such that the piezoelectric modulus d₃₃ is equal to at least 600 pm/V.

Regardless of the composition, the piezoelectric body itself, which is capable of being fired at the firing temperature described above and which has the piezoelectric modulus described above, is novel.

Specifically, the present invention also provides the piezoelectric body, which has the characteristics such that the firing temperature at the time of the production falls within the range of 800° C. to 900° C., and such that the piezoelectric modulus d₃₃ is equal to at least 600 pm/V.

[Piezoelectric Device]

The piezoelectric device in accordance with the present invention comprises:

i) the piezoelectric body in accordance with the present invention, and

ii) the electrodes for applying the electric field across the piezoelectric body.

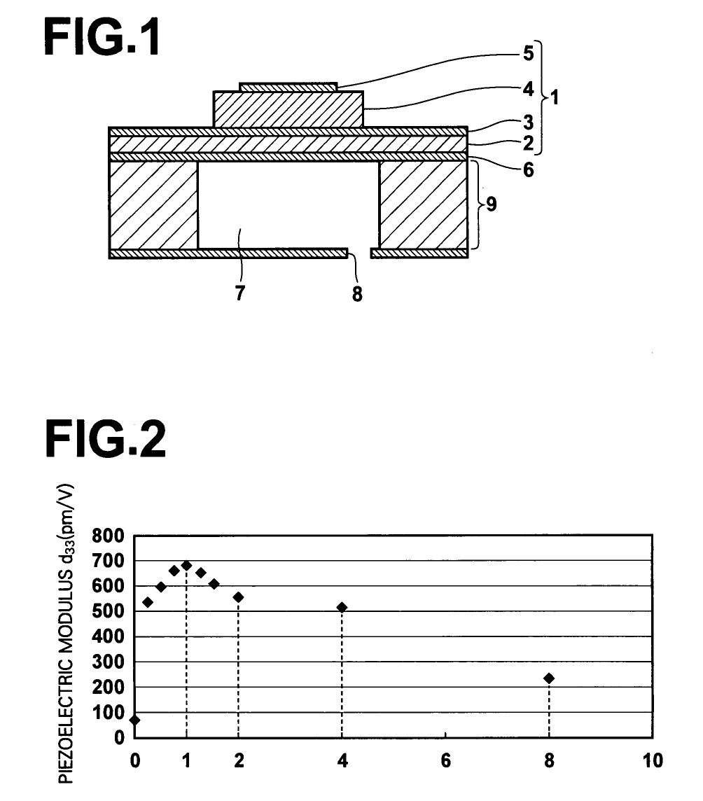

An embodiment of the piezoelectric device in accordance with the present invention will be described hereinbelow with reference to the accompanying drawings. In this embodiment, the piezoelectric device is designed for use in an ink jet type recording head. FIG. 1 is a sectional view showing a major part of an ink jet type recording head, which is provided with an embodiment of the piezoelectric device in accordance with the present invention, the sectional view being taken in the thickness direction of the piezoelectric device.

With reference to FIG. 1, a piezoelectric device 1 comprises a base plate 2, such as a silicon wafer. The piezoelectric device 1 also comprises a bottom electrode 3, a piezoelectric body 4 having the composition described above, and a top electrode 5, which are formed in this order on a surface of the base plate 2. An electric field is capable of being applied by the bottom electrode 3 and the top electrode 5 in the thickness direction of the piezoelectric body 4.

The form of the piezoelectric body 4 may be designed arbitrarily. The piezoelectric body 4 may take on the form of a bulk body or a film. By way of example, the bottom electrode 3 and the top electrode 5 may be formed on opposite surfaces of the piezoelectric body 4 constituted of a sintered body, and the base plate 2 may then be bonded to the surface of the bottom electrode 3. In this manner, the piezoelectric device 1 may be produced. Alternatively, the piezoelectric device 1 may be produced in the manner described below. Specifically, the piezoelectric body 4 taking on the form of the bulk body or the film may be directly formed on the bottom electrode 3 having been formed on the base plate 2. The formation of the piezoelectric body 4 may be performed by use of the known technique, e.g. the liquid phase technique, such as the sol gel technique or the organometal decomposition technique. Thereafter, the top electrode 5 may be formed on the piezoelectric body 4.

No limitation is imposed upon materials of the bottom electrode 3 and the top electrode 5. Examples of the materials of the bottom electrode 3 and the top electrode 5 include metals, such as Ag, Pt, and Ir; metal oxides, such as IrO₂, RuO₂, LaNiO₃, and SrRuO₃; and combinations of the above-enumerated metals and/or the above-enumerated metal oxides. The material of the bottom electrode 3 and the material of the top electrode 5 may be identical with each other or may be different from each other.

The piezoelectric device 1 is operated by control means (not shown), such as an actuating circuit, for controlling the electric field applied between the bottom electrode 3 and the top electrode 5.

The ink jet type recording head has the constitution described below. Specifically, a vibrating plate 6 is secured to a rear surface of the base plate 2 of the piezoelectric device 1 having the constitution described above. Also, an ink storing and discharging member 9 is secured to the vibrating plate 6. The ink storing and discharging member 9 comprises an ink chamber 7, in which an ink composition is to be stored. The ink storing and discharging member 9 also comprises an ink discharge opening 8. Alternatively, the vibrating plate 6 may be omitted, and the base plate 2 may act also as the vibrating plate. The ink jet type recording head is constituted such that the piezoelectric device 1 is expanded or contracted through alteration of the electric field applied across the piezoelectric device 1, and such that the discharge of the ink composition from the ink chamber 7 and the quantity of the ink composition discharged from the ink chamber 7 are thereby controlled.

The piezoelectric device 1 is provided with the piezoelectric body 4 in accordance with the present invention. Therefore, the practically required piezoelectric characteristics are capable of being obtained. Also, the piezoelectric body 4 is capable of being formed with the firing processing at a low temperature. Therefore, the piezoelectric device 1 is advantageous from the view points of the energy efficiency, the energy cost, and the like. Also, in cases where the piezoelectric body 4 having the composition described above is formed with, for example, the liquid phase technique, such as the sol gel technique or the organometal decomposition technique, and directly on the base plate 2, on which the bottom electrode 3 has been formed, the firing processing is capable of being performed at a temperature lower than with the conventional technique, and therefore adverse effects of heat on the base plate 2, and the like, are capable of being suppressed.

### EXAMPLES

The present invention will further be illustrated by the following non-limitative examples.

### Examples 1 to 15

Firstly, as the raw material particles for the (X) constituent, PbO particles, NiO particles, Nb₂O₅ particles, ZrO₂ particles, and TiO₂ particles were used (purity of each of the raw materials: at least 99.99%). The raw material particles described above were weighed out, such that a desired composition might be obtained. The raw material particles were subjected to sufficient dry mixing processing in a ball mill utilizing ZrO₂ balls. The mixed particles having thus been obtained were then subjected to firing processing at a temperature of 800° C. for five hours in an air atmosphere. In this manner, particles of three-component system lead zirconate titanate (X) were obtained. The composition of the three-component system lead zirconate titanate (X) was set to be 0.5Pb(Ni, Nb)O₃-0.15PbZrO₃-0.35PbTiO₃ (X-1).

Thereafter, PbO particles acting as the particles containing the (A) constituent, ZnO particles acting as the particles containing the (B) constituent, and one kind of particles acting as the particles containing the (C) constituent, which were selected from the group consisting of CeO₂ particles, Dy₂O₃ particles, and Yb₂O₃ particles (purity of each kind of the particles: at least 99.99%) were added to the aforesaid particles of the three-component system lead zirconate titanate (X) in quantities listed in Table 1 and Table 2 shown later. The resulting mixture was subjected to sufficient dry mixing processing in the same ball mill as that described above. In Table 1 and Table 2, the quantity of each of the (A) constituent, the (B) constituent, and the (C) constituent added is expressed in terms of the oxide quantity (parts by mass) with respect to 100 parts by mass of the three-component system lead zirconate titanate (X).

The mixed particles having thus been obtained were then subjected to uniaxial compression molding at a pressure of 50 MPa. The resulting compression molded body was fired at a temperature of 800° C. in an air atmosphere. In this manner, a sintered body constituted of the lead zirconate titanate type composition in accordance with the present invention, which contained the (X) constituent, the (A) constituent, the (B) constituent, and the (C) constituent, was obtained. the surfaces of the sintered body were polished, and a piezoelectric body was thus obtained. Thereafter, an Ag paste was coated onto the opposite surfaces of the obtained piezoelectric body, and the coating layer of the Ag paste was baked. In this manner, a bottom electrode and a top electrode were formed. The bottom electrode and the top electrode were subjected to known single polarization processing, and a piezoelectric device in accordance with the present invention was thereby obtained. The piezoelectric device having thus been obtained was cut, and measurement of the piezoelectric modulus d₃₃ was made.

### Examples 16, 17, and 18

A sintered body, a piezoelectric body, and a piezoelectric device constituted of the lead zirconate titanate type composition in accordance with the present invention were obtained in the same manner as that in Examples 1 to 15, except that the composition of the three-component system lead zirconate titanate (X) was set to be 0.35Pb(Ni, Nb)O₃-0.27PbZrO₃-0.38PbTiO₃ (X-2). Also, evaluation was made in the same manner.

### Example 19

A sintered body, a piezoelectric body, and a piezoelectric device constituted of the lead zirconate titanate type composition in accordance with the present invention were obtained in the same manner as that in Examples 1 to 15, except for the processing described below. Specifically, in Example 19, each of the (A) constituent, the (B) constituent, and the (C) constituent was added in the form of nitric acid salt. Also, the particles of the three-component system lead zirconate titanate (X) and the particles containing the (A) constituent, the (B) constituent, and the (C) constituent were subjected to wet mixing. After the mixing, the liquid constituents were removed with a rotary evaporator. Thereafter, the compression molding was performed. Also, evaluation was made in the same manner.

### Examples 20 and 21

A sintered body, a piezoelectric body, and a piezoelectric device constituted of the lead zirconate titanate type composition in accordance with the present invention were obtained in the same manner as that in Examples 1 to 15, except that the firing temperature was set at the temperature listed in Table 2. Also, evaluation was made in the same manner.

### Example 22

A sintered body, a piezoelectric body, and a piezoelectric device constituted of the lead zirconate titanate type composition in accordance with the present invention were obtained in the same manner as that in Examples 1 to 15, except that the firing atmosphere for the compression molded body was set at an Ar atmosphere. Also, evaluation was made in the same manner.

### Comparative Example 1

A sintered body, a piezoelectric body, and a piezoelectric device constituted of a lead zirconate titanate type composition for comparison were obtained in the same manner as that in Examples 1 to 15, except that the (A) constituent, the (B) constituent, and the (C) constituent were not added to the three-component system lead zirconate titanate (X), and except that the firing temperature was set at 1,250° C. Also, evaluation was made in the same manner.

### Comparative Example 2

A sintered body, a piezoelectric body, and a piezoelectric device constituted of a lead zirconate titanate type composition for comparison were obtained in the same manner as that in Comparative Example 1, except that the firing temperature was set at 800° C. as in Examples 1 to 15. Also, evaluation was made in the same manner.

### Comparative Examples 3, 4, and 5

A sintered body, a piezoelectric body, and a piezoelectric device constituted of a lead zirconate titanate type composition for comparison were obtained in the same manner as that in Examples 1 to 15, except that one of the (A) constituent, the (B) constituent, and the (C) constituent was not added to the three-component system lead zirconate titanate (X), and except that the composition of the added constituents was set as listed in Table 3 shown later. Also, evaluation was made in the same manner.

(Results)

Results of evaluation as shown in Tables 1, 2, and 3 were obtained.

In Comparative Example 1, the (A) constituent, the (B) constituent, and the (C) constituent were not added, and the firing processing was performed at a high temperature as in the conventional technique (firing temperature: 1,250° C.). In Comparative Example 1, in which the high temperature firing processing was performed, thought the (A) constituent, the (B) constituent, and the (C) constituent were not added, a high piezoelectric modulus (d₃₃=700 pm/V) was obtained. The high piezoelectric modulus is the piezoelectric characteristics, which the PNN-PZT fundamentally has.

However, in Comparative Example 2, in which the composition was the same as that in Comparative Example 1, and in which the firing processing was performed at a low temperature (firing temperature: 800° C.), the piezoelectric modulus d₃₃ was 70 pm/V, and the piezoelectric modulus was thus markedly low. Also, in Comparative Examples 3, 4, and 5 (firing temperature: 800° C.), in which only two constituents selected from among the (A) constituent, the (B) constituent, and the (C) constituent were added, though the piezoelectric modulus was enhanced over the piezoelectric modulus in Comparative Example 2, the piezoelectric modulus d₃₃ was at most 330 pm/V.

In Examples 1 to 20, in which the (A) constituent, the (B) constituent, and the (C) constituent were added to the three-component system lead zirconate titanate (X), though the firing processing was performed at a low temperature falling within the range of 800° C. to 900° C., a piezoelectric modulus higher than the piezoelectric modulus obtained in Comparative Example 2 was obtained. Specifically, it was possible to accomplish the piezoelectric modulus of d₃₃≧500 pm/V. It was also possible to accomplish the piezoelectric modulus of d₃₃≧600 pm/V. Particularly, in Example 1, in which, with respect to 100 parts by mass of the three-component system lead zirconate titanate (X), the quantity of the (A) constituent added was equal to 2.0 parts by mass, expressed in terms of the oxide quantity, the quantity of the (B) constituent added was equal to 1.0 part by mass, expressed in terms of the oxide quantity, and the quantity of the (C) constituent added was equal to 0.5 part by mass, expressed in terms of the oxide quantity, the piezoelectric modulus of d₃₃=680 pm/V was capable of being obtained. Thus in Example 1, the piezoelectric modulus approximately equivalent to the piezoelectric modulus obtained in Comparative Example 1 (high temperature firing processing) was capable of being obtained.

In Examples 2 to 9, the blending ratios among the (A) constituent, the (B) constituent, and the (C) constituent were kept identical with the blending ratios in Example 1, and the total quantity of the (A) constituent, the (B) constituent, and the (C) constituent added was set at different values. FIG. 2 shows the relationship between the total quantity (T) of the (A) constituent, the (B) constituent, and the (C) constituent added and the piezoelectric modulus in Examples 1 to 9, in which the total quantity of the (A) constituent, the (B) constituent, and the (C) constituent added in Example 1 is taken as 1. For example, T=0.25 corresponds to Example 2, T=0.5 corresponds to Example 3, and T=1 corresponds to Example 1. Also, T=2 corresponds to Example 7, T=4 corresponds to Example 8, and T=8 corresponds to Example 9.

FIG. 2 shows that, in proportion as the total quantity of the (A) constituent, the (B) constituent, and the (C) constituent added shifts from the total quantity added in Example 1, in which the highest piezoelectric modulus is obtained, the piezoelectric modulus becomes low little by little.

The inventors consider that, since the piezoelectric modulus d₃₃ may be expressed by the formula shown below, in proportion to the increase in total quantity of the (A) constituent, the (B) constituent, and the (C) constituent added, a relative dielectric constant is apt to become low, and the piezoelectric modulus is apt to become low.

d₃₃=k₃₃(ε/s)^{1/2}

in which k₃₃ represents the electro-mechanical coupling constant, ε represents the relative dielectric constant, and s represents the elastic constant.

Specifically, in Examples 1 to 9, the piezoelectric modulus of d₃₃≧500 pm/V was capable of being obtained in cases where 0<T≦4, i.e. in cases where, with respect to 100 parts by mass of the three-component system lead zirconate titanate (X), the quantity of the (A) constituent added fell within the range of more than 0 part by mass to 8.0 parts by mass, inclusive, expressed in terms of an oxide quantity, the quantity of the (B) constituent added fell within the range of more than 0 part by mass to 4.0 parts by mass, inclusive, expressed in terms of the oxide quantity, and the quantity of the (C) constituent added fell within the range of more than 0 part by mass to 2.0 parts by mass, inclusive, expressed in terms of the oxide quantity.

Also, in Examples 1 to 9, the piezoelectric modulus of d₃₃≧600 pm/V was capable of being obtained in cases where 0.5<T≦1.5, i.e. in cases where, with respect to 100 parts by mass of the three-component system lead zirconate titanate (X), the quantity of the (A) constituent added fell within the range of 1.0 part by mass to 3.0 parts by mass, expressed in terms of an oxide quantity, the quantity of the (B) constituent added fell within the range of 0.5 part by mass to 1.5 parts by mass, expressed in terms of the oxide quantity, and the quantity of the (C) constituent added fell within the range of 0.25 part by mass to 0.75 part by mass, expressed in terms of the oxide quantity.

In Examples 10 and 11, in which the kind of the (C) constituent was altered, the same results as those obtained in Examples 1 to 9 were capable of being obtained. Also, in Examples 12, 13, 14, and 15, in which the blending ratios among the (A) constituent, the (B) constituent, and the (C) constituent were altered, the same results as those obtained in Examples 1 to 9 were capable of being obtained. Further, in Examples 16, 17, and 18, in which the composition of the (X) constituent was altered, the same results as those obtained in Examples 1 to 9 were capable of being obtained.

Also, from a comparison made among Examples 1 to 21 and Example 22, it was revealed that an oxygen-containing atmosphere, such as an air atmosphere, was appropriate as the firing atmosphere.

TABLE 1

| | | (A) | (B) | | | | | | | |
|---|---|---|---|---|---|---|---|---|---|---|
| | | quantity* | quantity* | | | | | | Piezoelectric | |
| | | (parts by | (parts by | (C) quantity* | | | | Firing | constant | |
| | | mass) | mass) | (parts by mass) | | | Firing | temperature | d₃₃ | |
| Example | (X) | Pb | Zn | Ce | Dy | Yb | atmosphere | (° C.) | (pm/V) | Remarks |
| 1 | X-1 | 2.0 | 1.0 | 0.5 | — | — | Air | 800 | 680 | |
| 2 | X-1 | 0.5 | 0.25 | 0.125 | — | — | Air | 800 | 530 | |
| 3 | X-1 | 1.0 | 0.5 | 0.25 | — | — | Air | 800 | 600 | |
| 4 | X-1 | 1.5 | 0.75 | 0.375 | — | — | Air | 800 | 660 | |
| 5 | X-1 | 2.5 | 1.25 | 0.625 | — | — | Air | 800 | 650 | |
| 6 | X-1 | 3.0 | 1.5 | 0.75 | — | — | Air | 800 | 610 | |
| 7 | X-1 | 4.0 | 2.0 | 1.0 | — | — | Air | 800 | 550 | |
| 8 | X-1 | 8.0 | 4.0 | 2.0 | — | — | Air | 800 | 510 | |
| 9 | X-1 | 16.0 | 8.0 | 4.0 | — | — | Air | 800 | 230 | |
| 10 | X-1 | 2.0 | 1.0 | — | 1.0 | — | Air | 800 | 665 | |
| 11 | X-1 | 2.0 | 1.0 | — | — | 1.0 | Air | 800 | 670 | |

*The quantity of each of the (A) to (C) constituents added is expressed in terms of the oxide quantity with respect to 100 parts by mass of the (X) constituent.

TABLE 2

| | | (A) | (B) | | | | | | | |
|---|---|---|---|---|---|---|---|---|---|---|
| | | quantity* | quantity* | | | | | | Piezoelectric | |
| | | (parts by | (parts by | (C) quantity* | | | | Firing | constant | |
| | | mass) | mass) | (parts by mass) | | | Firing | temperature | d₃₃ | |
| Example | (X) | Pb | Zn | Ce | Dy | Yb | atmosphere | (° C.) | (pm/V) | Remarks |
| 12 | X-1 | 1.0 | 1.0 | 0.5 | — | — | Air | 800 | 640 | |
| 13 | X-1 | 0.5 | 1.0 | 0.5 | — | — | Air | 800 | 590 | |
| 14 | X-1 | 2.0 | 0.5 | 0.5 | — | — | Air | 800 | 530 | |
| 15 | X-1 | 2.0 | 1.0 | 1.0 | — | — | Air | 800 | 645 | |
| 16 | X-2 | 2.0 | 1.0 | 0.5 | — | — | Air | 800 | 635 | |
| 17 | X-2 | 2.0 | 1.0 | — | 1.0 | — | Air | 800 | 630 | |
| 18 | X-2 | 2.0 | 1.0 | — | 2.0 | — | Air | 800 | 610 | |
| 19 | X-1 | 2.0 | 1.0 | 0.5 | — | — | Air | 800 | 675 | ** |
| 20 | X-1 | 2.0 | 1.0 | 0.5 | — | — | Air | 900 | 695 | |
| 21 | X-1 | 2.0 | 1.0 | 0.5 | — | — | Air | 700 | 480 | |
| 22 | X-1 | 2.0 | 1.0 | 0.5 | — | — | Ar | 800 | 40 | |

*The quantity of each of the (A) to (C) constituents added is expressed in terms of the oxide quantity with respect to 100 parts by mass of the (X) constituent.
** Added as a nitric acid salt, wet mixing

TABLE 3

| | | (A) | (B) | | | | | | | |
|---|---|---|---|---|---|---|---|---|---|---|
| | | quantity* | quantity* | | | | | | Piezoelectric | |
| | | (parts by | (parts by | (C) quantity* | | | | Firing | constant | |
| Comparative | | mass) | mass) | (parts by mass) | | | Firing | temperature | d₃₃ | |
| Example | (X) | Pb | Zn | Ce | Dy | Yb | atmosphere | (° C.) | (pm/V) | Remarks |
| 1 | X-1 | — | — | — | — | — | Air | 1,250 | 700 | |
| 2 | X-1 | — | — | — | — | — | Air | 800 | 70 | |
| 3 | X-1 | 2.0 | — | 0.5 | — | — | Air | 800 | 160 | |
| 4 | X-1 | 2.0 | 1.0 | — | — | — | Air | 800 | 330 | |
| 5 | X-1 | — | 1.0 | 0.5 | — | — | Air | 800 | 115 | |

*The quantity of each of the (A) to (C) constituents added is expressed in terms of the oxide quantity with respect to 100 parts by mass of the (X) constituent.

### INDUSTRIAL APPLICABILITY

The lead zirconate titanate type composition in accordance with the present invention is capable of being utilized appropriately for actuators for use in ink jet type recording heads, magnetic recording and reproducing heads, micro electro-mechanical systems (MEMS) devices, ultrasonic probes, and the like.

What is claimed is:

1. A lead zirconate titanate type composition, containing:
i) a three-component system lead zirconate titanate (X), which may be represented by the general formula of Pb(Ni, Nb)O₃—PbZrO₃—PbTiO₃,
ii) an (A) constituent, which is Pb in excess of a quantity conforming to a stoichiometric ratio,
iii) a (B) constituent, which is Zn, and
iv) a (C) constituent, which is at least one kind of rare earth element selected from the group consisting of Ce, Yb, and Dy,
the (A) constituent, the (B) constituent, and the (C) constituent being added to the three-component system lead zirconate titanate (X).

2. A lead zirconate titanate type composition as defined in claim 1 wherein, with respect to 100 parts by mass of the three-component system lead zirconate titanate (X):
a quantity of the (A) constituent added falls within the range of more than 0 part by mass to 8.0 parts by mass, inclusive, expressed in terms of an oxide quantity,
a quantity of the (B) constituent added falls within the range of more than 0 part by mass to 4.0 parts by mass, inclusive, expressed in terms of the oxide quantity, and
a quantity of the (C) constituent added falls within the range of more than 0 part by mass to 2.0 parts by mass, inclusive, expressed in terms of the oxide quantity,
the quantity of each of the constituents added, expressed in terms of the oxide quantity, being the quantity expressed in terms of the oxide quantity in cases where the constituent is added in the form of the oxide.

3. A lead zirconate titanate type composition as defined in claim 1 wherein, with respect to 100 parts by mass of the three-component system lead zirconate titanate (X):
a quantity of the (A) constituent added falls within the range of 1.0 part by mass to 3.0 parts by mass, expressed in terms of an oxide quantity,
a quantity of the (B) constituent added falls within the range of 0.5 part by mass to 1.5 parts by mass, expressed in terms of the oxide quantity, and
a quantity of the (C) constituent added falls within the range of 0.25 part by mass to 0.75 part by mass, expressed in terms of the oxide quantity,
the quantity of each of the constituents added, expressed in terms of the oxide quantity, being the quantity expressed in terms of the oxide quantity in cases where the constituent is added in the form of the oxide.

4. A lead zirconate titanate type composition as defined in claim 1 wherein the lead zirconate titanate type composition takes on the form of a sintered body having been produced with a process comprising the steps of:
i) compression molding raw material particles, which contain the constituent elements of the three-component system lead zirconate titanate (X), the (A) constituent, the (B) constituent, and the (C) constituent, into a predetermined shape, and
ii) firing a compression molded body having thus been obtained.

5. A lead zirconate titanate type composition as defined in claim 4 wherein the raw material particles contain the (A) constituent, the (B) constituent, and the (C) constituent in the forms of oxides and/or acid salts.

6. A lead zirconate titanate type composition as defined in claim 4 wherein a firing temperature for the compression molded body falls within the range of 700° C. to 900° C.

7. A lead zirconate titanate type composition as defined in claim 4 wherein a firing atmosphere for the compression molded body is an oxygen-containing atmosphere.

8. A process for producing a lead zirconate titanate type composition as defined in claim 1, comprising the steps of:
i) performing molding processing for compression molding raw material particles, which contain the constituent elements of the three-component system lead zirconate titanate (X), the (A) constituent, the (B) constituent, and the (C) constituent, into a predetermined shape, and
ii) performing firing processing for firing a compression molded body having been obtained from the molding processing.

9. A process for producing a lead zirconate titanate type composition as defined in claim 8 wherein, in the firing processing step, the compression molded body is fired at a firing temperature falling within the range of 700° C. to 900° C.

10. A process for producing a lead zirconate titanate type composition as defined in claim 8 wherein, in the firing processing step, the compression molded body is fired in an oxygen-containing atmosphere.

11. A piezoelectric body, containing:
i) a three-component system lead zirconate titanate (X), which may be represented by the general formula of Pb(Ni, Nb)O₃—PbZrO₃—PbTiO₃,
ii) an (A) constituent, which is Pb in excess of a quantity conforming to a stoichiometric ratio,
iii) a (B) constituent, which is Zn, and
iv) a (C) constituent, which is at least one kind of rare earth element selected from the group consisting of Ce, Yb, and Dy,
the (A) constituent, the (B) constituent, and the (C) constituent being added to the three-component system lead zirconate titanate (X).

12. A piezoelectric body as defined in claim 11 wherein the piezoelectric body has characteristics such that a firing temperature at the time of production falls within the range of 800° C. to 900° C., and such that a piezoelectric modulus d₃₃ is equal to at least 600 pm/V.

13. A piezoelectric body, having characteristics such that a firing temperature at the time of production falls within the range of 800° C. to 900° C., and such that a piezoelectric modulus d₃₃ is equal to at least 600 pm/V.

14. A piezoelectric device, comprising:
i) a piezoelectric body as defined in claim 11, and
ii) electrodes for applying an electric field across the piezoelectric body.

15. A piezoelectric device, comprising:
i) a piezoelectric body as defined in claim 13, and
ii) electrodes for applying an electric field across the piezoelectric body.
